(19) United States
(12) Patent Application Publication
(10) Pub. No.: US 2026/0295862 A1
(43) Pub. Date: Oct. 1, 2026

(54) SYSTEM AND METHOD FOR VERTICAL ROBOT SENSING AND/OR CONTROL

(71) Applicant: Mytra, Inc., Brisbane, CA (US)

(72) Inventors: Parker Robinson, Brisbane, CA (US); William Makinen, Brisbane, CA (US); Gagandeep Thable, Brisbane, CA (US); Stefan Ozog, Winnipeg, CA (US); Ryan Williams, Brisbane, CA (US)

(73) Assignee: Mytra, Inc., Brisbane, CA (US)

(21) Appl. No.: 19/633,088

(22) Filed: Mar. 30, 2026

Related U.S. Application Data
(60) Provisional application No. 63/779,836, filed on Mar. 28, 2025.

(51) Int. Cl. B25J 13/08; B25J 9/00; B25J 9/10

(52) U.S. Cl. CPC B25J 13/089; B25J 9/0096; B25J 9/102

(57) ABSTRACT

The system can include: a sensor suite, a computing system, a deployment mechanism, a helical drive mechanism and/or any other suitable components. The system can optionally include a rack. However, the system can additionally or alternatively include any other suitable set of components. The system functions to estimate the relative ego pose of the robot relative to the rack. Additionally or alternatively, the system can control the helical drive mechanism to facilitate rack engagement and/or control vertical translation.

### CROSS REFERENCE TO RELATED APPLICATIONS

This application claims the benefit of U.S. Provisional Application No. 63/779,836, filed 28 Mar. 2025, which is incorporated herein in its entirety by this reference.

This application is related to U.S. application Ser. No. 18/531,184, filed 6 Dec. 2023, and U.S. application Ser. No. 19/046,366, filed 5 Feb. 2025, each of which is incorporated herein in its entirety by this reference.

### TECHNICAL FIELD

This invention relates generally to the robotics and storage automation fields, and more specifically to a new and useful sensing system and/or method in the robotics and storage automation fields.

### BRIEF DESCRIPTION OF THE FIGURES

FIG. 1 is a flowchart representation of a variant of the method.

FIG. 2 is a schematic representation of a variant of the system.

FIG. 3A is a partial schematic representation of a variant of the system from a top view.

FIG. 3B is a partial schematic representation of a variant of the system from a side view.

FIG. 4A is a schematic illustration of a variant of the system.

FIG. 4B is an example waveform for a graph of D-drive travel versus sensed distance in the schematic illustration in FIG. 4A.

FIG. 5 is a schematic of a variant of the system and/or method.

FIG. 6 is a graph of measured distance versus distance from the rack for multiple rack heights.

FIG. 7 is a schematic illustration of a variant of the system.

FIG. 8 is a schematic illustration of a variant of the system.

FIG. 9 is a schematic illustration of a variant of the system.

FIGS. 10A-10B are a first and second schematic illustration of rack engagement relative to helical drive rotation angle.

FIG. 11 is a partial isometric view of a variant of the system.

FIG. 12 is an example dataset of 15 depth image frames, with an ego z-height estimated for each frame.

FIG. 13A-13B are an example of a sensor capturing measurements during traversal of a cell.

FIG. 14 is a view of a variant of the rack and helical drive mechanism.

FIGS. 15A-15C are views of a variant of the helical drive mechanism.

FIG. 16 is a view of a variant of the robot within a support frame structure.

FIG. 17 is a view of a variant of the rack and reference features thereof.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

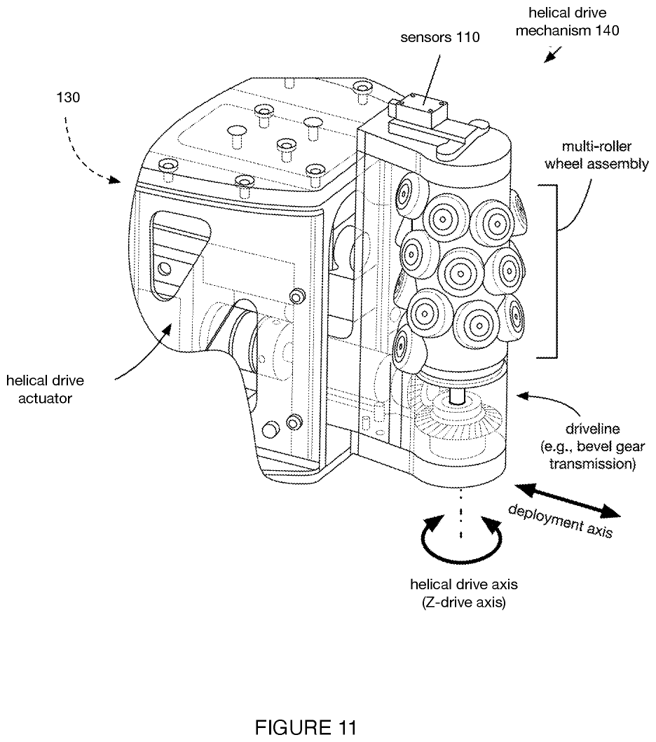

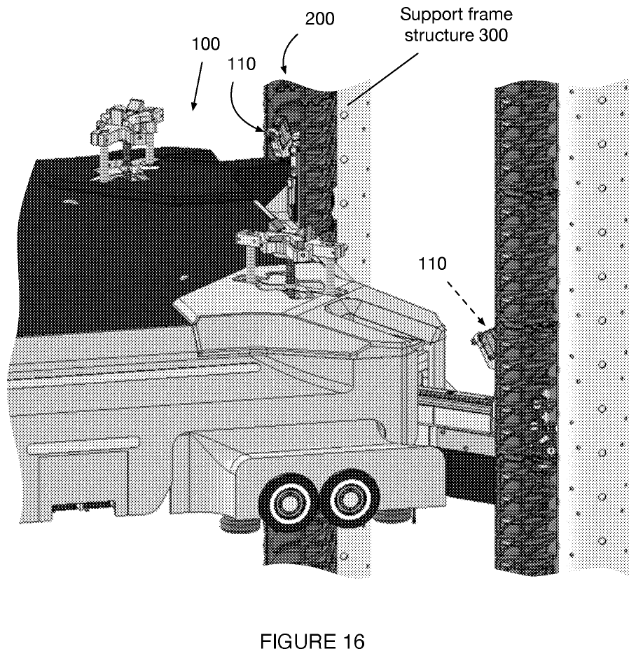

The system 100 can include: a sensor suite 110, a computing system 120, a deployment mechanism 130, a helical drive mechanism 140 and/or any other suitable components. The system can optionally include a rack 200 (e.g., within a support frame structure 300; example shown in FIG. 16). However, the system 100 can additionally or alternatively include any other suitable set of components. The system functions to estimate the relative ego pose (e.g., helical drive angular rotation and/or vertical position) of the robot relative to the rack. Additionally or alternatively, the system can function to control the helical drive mechanism to facilitate rack engagement and/or vertical control (e.g., granular control, such as within 1 mm, even under coarse relative tolerances, such as frame flexure/displacements greater than 1 cm). An example of the system is shown in FIG. 11.

Additionally, the system can function to facilitate execution of method 1000 and/or can be used in conjunction with the systems and/or method(s) as described in U.S. application Ser. No. 19/046,366, filed 5 Feb. 2025, which is incorporated herein in its entirety by this reference.

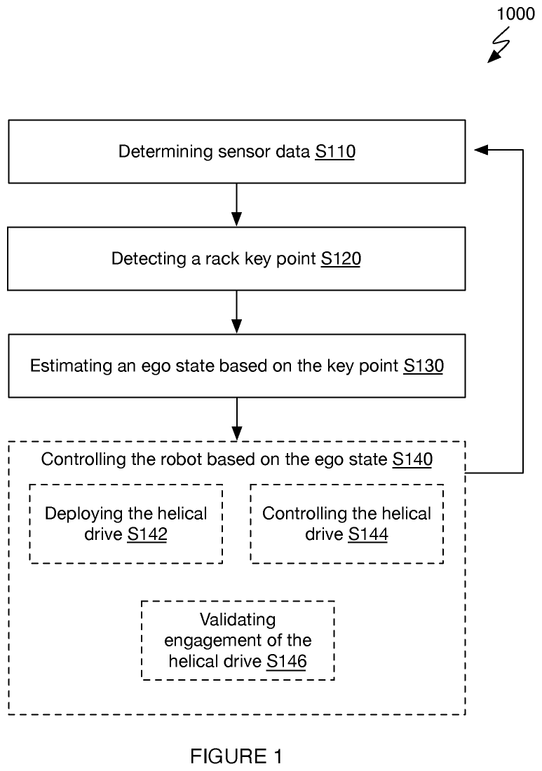

The method 1000, an example of which is shown in FIG. 1, can include: determining sensor data S110; detecting a rack key point S120; and estimating an ego state based on the key point S130. The method can optionally include controlling the robot based on the ego state S140. The method functions to facilitate robot pose estimation relative to a rack. Additionally or alternatively, the method can function to facilitate rack engagement and/or granular control of a helical drive mechanism (e.g., under coarse structural tolerances).

The term “drive” and/or “drive mechanism” may be interchangeably utilized herein to refer to an electric drivetrain (e.g., an electric drivetrain, including a traction/drive motor and power transmission components, gearboxes, etc.) and/or independent submodules thereof (e.g., for a split electric drivetrains with no mechanical coupling/differential, etc.), but can additionally or alternatively refer to any suitable tractive drive systems, powertrains/drivetrains, and/or power transmission schemes.

It is understood that, in some variants, the “robot” as referenced may be equivalently referenced herein as an electric vehicle (EV) or battery electric vehicle (BEV) as appropriate (e.g., where the robot includes an onboard battery). However, the robot, drive systems, and/or control system thereof may be integrated with any suitable power source(s) and/or power transmission scheme(s).

The term “substantially” as utilized herein can mean: exactly, approximately, within a predetermined threshold or tolerance, and/or have any other suitable meaning.

### 1.2 Illustrative Examples

In an illustrative example, a system 100 (e.g., a robot) can include: a chassis 150, a computing system 120 onboard the chassis, and a sensor suite 110 communicatively coupled to the controller. The robot can include a plurality of orthogonal drive mechanisms (e.g., X-drive, Y-drive, Z-drive, etc.) controlled by an onboard computing system (and/or a controller thereof). Each orthogonal drive mechanism can be articulated between a retracted configuration and a deployed/engaged configuration by a (respective) set of deployment mechanisms (e.g., D-drive for diagonal deployment of the Z-drive mechanism). In a first example, two sets of (orthogonal) lateral drive mechanisms 160 can be deployed using a respective set(s) of linkages (e.g., 4 bar linkage; actuated along an arcuate deployment trajectory by linkage transformation). For instance, first pair of lateral-drive mechanisms (e.g., X-drive mechanisms on opposing sides of a frontal plane; such as linear rail trolleys, etc.) can be independently actuated by a first and a second actuator along trajectories constrained by a first and second linkage, respectively (e.g., four bar linkage, with an anti-roll bar coupling sub-assemblies on opposing sides of the midsagittal plane). In a second example, a vertical drive mechanism(s) can be deployed at the corners of the chassis (e.g., deployed outward beyond a rectangular footprint defined by the lateral drive mechanisms and/or a planar intersection of the perpendicular X-drive mechanism travels; D-drive).

Each degree of freedom can include a single actuator/mechanism or multiple (independent) actuators/mechanisms (e.g., two, four, etc.; a pairs of actuators, multiple pairs of actuators, etc.). In one example, the Z-drive can include a plurality of helical drive mechanisms (e.g., at each corner of the vertical footprint or column; four substantially parallel Z-drive axes) which can be independently actuated/controlled (e.g., simultaneously controlled to facilitate Z traversal while maintaining chassis orientation). In a first example, the robot can include four Z-drive actuators (e.g., all same-handed helical drives; two right-hand helical drives and two left-hand helical drives, paired diagonally or otherwise), each with a respective (linear) deployment actuator. In a second example, the robot can include four X-drive actuators, including: a front pair of two X-drive actuators (e.g., on opposing sides of a midsagittal plane) coupled by a linkage and collectively actuated by a front actuator; and a rear pair of two X-drive actuators (e.g., on opposing sides of a midsagittal plane) coupled by a linkage and collectively actuated by a rear actuator. In a third example, the robot can include four Y-drive actuators, including: a left pair of two Y-drive actuators (e.g., on opposing sides of a frontal plane) coupled by a linkage and collectively actuated by a left actuator; and a right pair of two Y-drive actuators (e.g., on opposing sides of a frontal plane) coupled by a linkage and collectively actuated by a right actuator. In variants, the robot and/or degrees of actuator freedom thereof (or a subset thereof) can be rotationally symmetric about a vertical axis (e.g., 180 degree rotation, 90 degree rotation, etc.), mirrored about a midsagittal plane, mirrored about a (mid-)frontal plane, mirrored about a (diagonal) reference plane (e.g., defined by parallel rotational axes of opposite Z-drives, etc.), and/or can define any other suitable symmetry(ies).

Additionally or alternatively, in some variants, the lateral drive deployment mechanisms (e.g., X deployment and Y deployment mechanisms) can be controlled to granularly adjust the Z-height and/or pose (e.g., in pitch/roll) to facilitate Z-engagement. For example, the lateral drives can be actuated to adjust the Z-drive within the height of a single ‘step’ of the rack (e.g., +/−5 mm; unidirectional control in the retraction direction when fully deployed during nominal lateral control). Additionally, in variants with excess travel of the lateral drive wheelsets (e.g., greater than a single rack step; bidirectional control; where excess travel on the order of +/−10 mm remains available with the wheel set engaged), the lateral deployment mechanisms can be used interchangeably and/or redundantly with the helical drive for granular height and/or pose adjustment to during the method. However, the lateral deployment mechanism can alternatively be locked and/or not utilized during Z-engagement.

However, the robot can include any other suitable degrees of freedom.

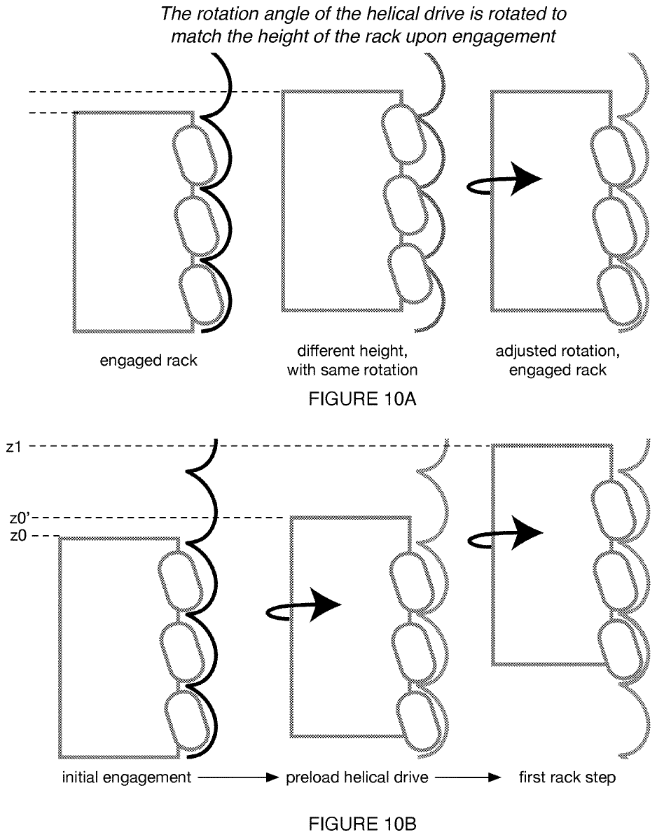

In variants, the helical drive mechanisms can be individually and/or collectively controlled as a function of the estimated Z-height (e.g., Z-drive control), which can be partially or fully mathematically decoupled from controls for deployment (e.g., S142; D-drive deployment) and/or engagement of the rack. In particular, the rotation angle of the helical drive mechanism(s) can be controlled to ‘mesh’ with the rack upon initial engagement based on the relative ego state (e.g., angle and/or height of the Z-drive; as estimated by S130), an example of which is shown in FIG. 10A.

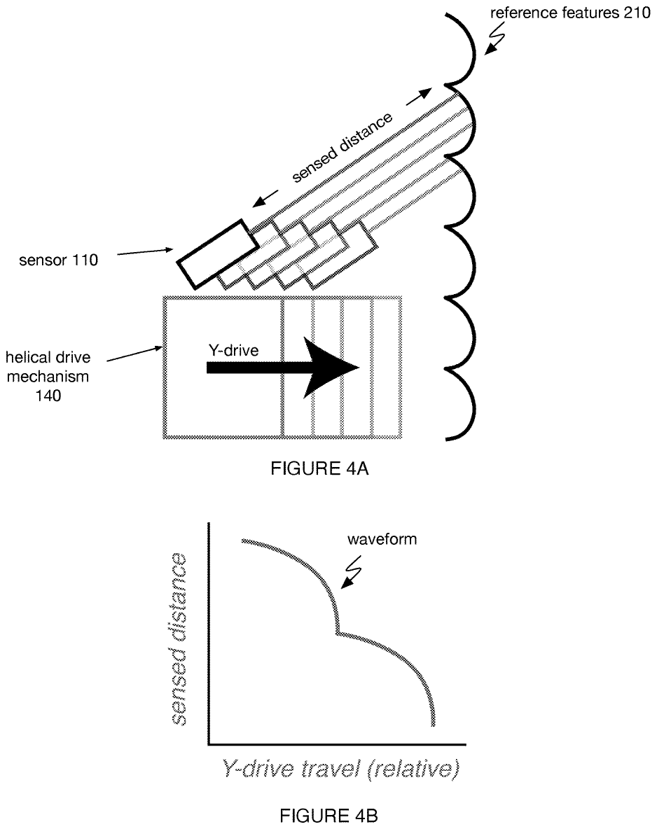

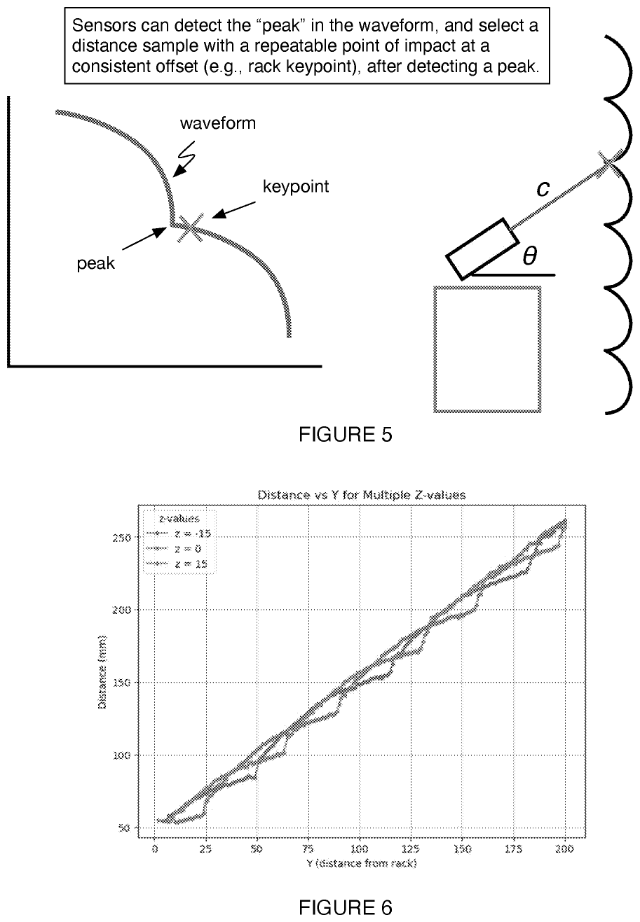

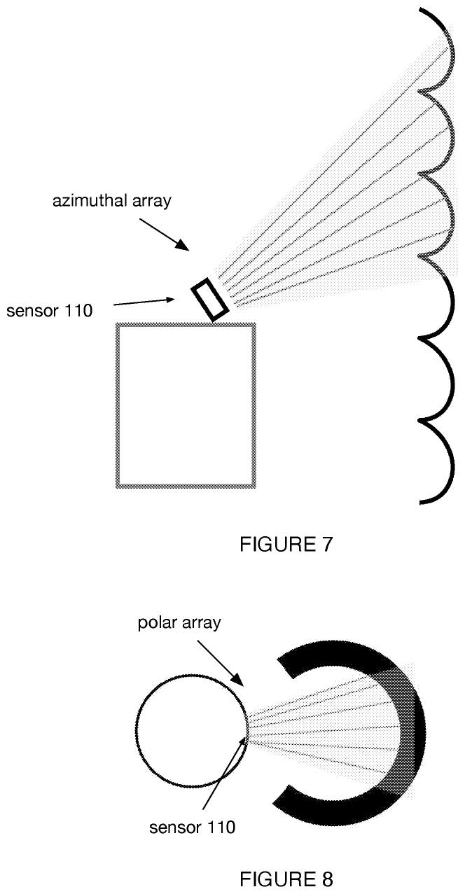

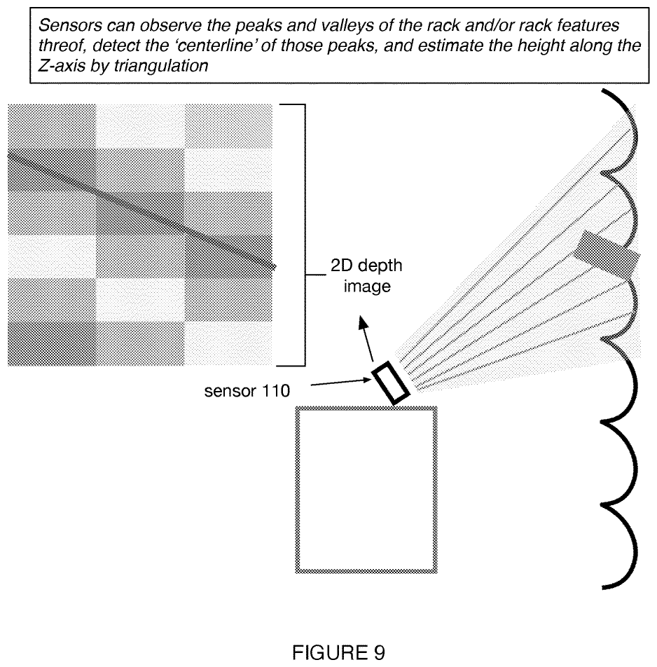

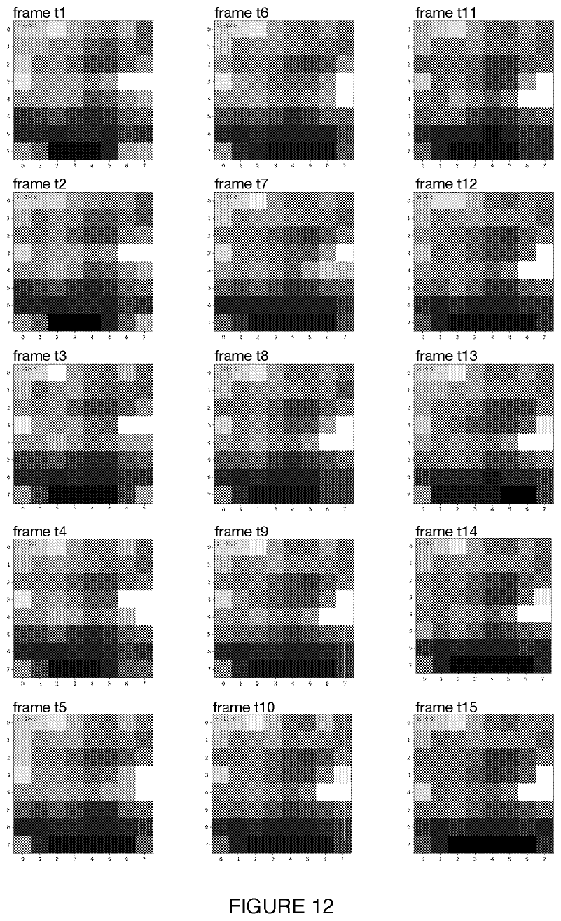

The ego state can be estimated by detecting peaks, key points, and/or features in a sensed distance waveform (e.g., as a function of the sampled distance to the rack during deployment travel along the diagonal axis, an example of which is shown in FIG. 4A and FIG. 4B; as a function of the sampled distance to the rack during a cell entering operation, etc.). In a first variant, the ego state can be estimated by tracking key points across a time series of measurements from a single sensor (e.g., at a fixed and/or known angle), examples of which is shown in FIG. 5 and FIG. 6. In a second variant, the ego state can be estimated (e.g., from a single data frame) based on a 1-D array sensor data (e.g., azimuthal array, an example is shown in FIG. 7; polar array, an example is shown in FIG. 8). In a third variant, the ego state can be estimated from a 2-D array of sensor data (e.g., azimuthal and polar array; an example is shown in FIG. 9 and FIG. 12). In a fourth variant, a (pre-)trained model can detect key points and/or estimate ego state parameter(s) in conjunction with any one or more of the first, second, and third variants.

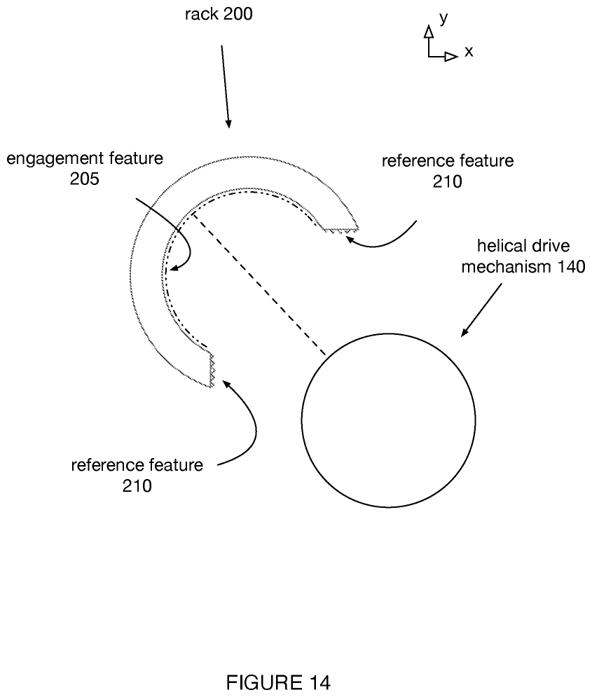

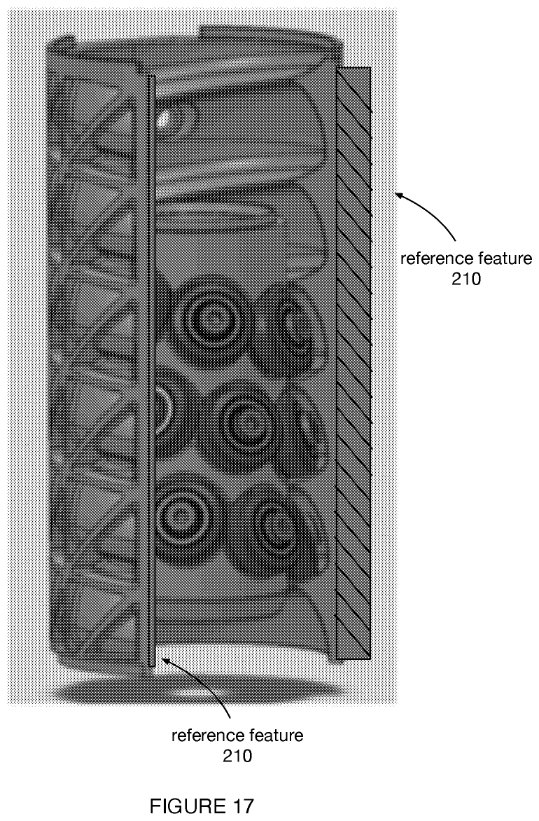

In variants, the ego state can be estimated based on measurements (e.g., a waveform) capturing a set of reference features 210 distinct from the helical rack engagement features (e.g., reference features that are separate from the helical pattern used for worm engagement; example shown in FIG. 14). For example, the rack (e.g., an entry rack portion of the rack) can include one or more molded reference features arranged on a lip or edge of the rack, offset from the helical engagement surface and separate from the helical engagement pattern (e.g., so as to reduce the risk of impeding the helical drive mechanism; example shown in FIG. 17). Such features can include three-dimensional geometry (e.g., a slope, a ramp, a step, a notch, a ridge, and/or any other suitable three-dimensional profile) designed to produce a deterministic distance measurement as a function of sensor position along the longitudinal axis of the rack. In variants, the reference features can be integrated into the rack as a unitary component (e.g., molded with the entry rack as part of the same manufacturing process). In variants, the reference features can be arranged on both sides of the rack (e.g., on opposing lips of the rack) to facilitate sensing regardless of the direction from which the robot enters the cell.

### 3. Benefits

Variations of the technology can afford several benefits and/or advantages.

First, variants of the technology confer the benefit of enabling reliable engagement of a helical drive mechanism with a rack under coarse structural tolerances (e.g., frame flexure and/or displacements greater than 1 cm), which can in turn enable robust vertical traversal of a robot within a storage structure without requiring tight manufacturing tolerances and/or rigid frame construction. In examples, the system can achieve alignment accuracy within approximately 1-2 millimeters even when the rack and/or frame structure has deflected by a centimeter or more due to variable loads, thermal expansion, and/or structural aging, thereby decoupling the precision requirements of the sensing and control system from the precision requirements of the physical structure.

Second, variants of the technology can reduce hardware cost and complexity by utilizing low-cost sensors (e.g., a single-point distance sensor) in conjunction with existing degrees of freedom of the robot (e.g., deployment motion along the D-drive axis; lateral motion via drive wheels entering a cell) to generate spatially rich sensor data without requiring additional mechanical scanning mechanisms, high-resolution depth cameras, and/or precision-engineered sensor mounts. In examples, a single-point sensor rigidly mounted to the helical drive mechanism can be swept across rack features by the robot's own actuation to produce a two-dimensional spatial profile, thereby providing measurements across a spatial path using a low-dimensional (e.g., single-point, etc.) sensor.

Third, variants of the technology can facilitate independent and concurrent control of a plurality of helical drive mechanisms (e.g., four helical drives at respective corners of the robot), each with a respective sensor, enabling the robot to estimate and correct for per-corner variations in rack position, frame deflection, and/or structural tolerance independently. In particular, variants can decouple the helical drive alignment control (Z-drive) from the deployment control (D-drive), enabling the alignment to be performed synchronously with deployment without requiring sequential or iterative engagement attempts (e.g., trial and error).

Fourth, variants of the technology can reduce cycle time and increase throughput within the storage structure by enabling first-attempt engagement of the helical drive with the rack (e.g., without requiring trial-and-error approaches that consume multiple engagement cycles, store and recall previously learned positions, and/or periodically relearn positions as the structure sags or warps over time). In examples, the ego state estimation and helical drive alignment can be performed in real time during a single deployment or cell-entry motion, such that the helical drive is aligned and ready to engage upon completion of deployment.

Fifth, variants of the technology can improve robustness and maintainability of the system by utilizing sensing approaches that are tolerant of sensor alignment variability (e.g., agnostic to minor variations in sensor mounting angle due to mechanical tolerances and/or maintenance), by utilizing features on the rack that are integrated as unitary components (e.g., molded into an entry rack section without requiring separate parts, adhesive, printing, or post-processing), and/or by enabling fault detection during vertical traversal (e.g., detecting unintentional disengagement, verifying traversal speed as a redundancy for rotary encoders, and/or detecting rack wear) using the same sensor hardware used for initial alignment.

Additionally or alternatively, the system and method can confer any other suitable benefit(s).

### 4. System

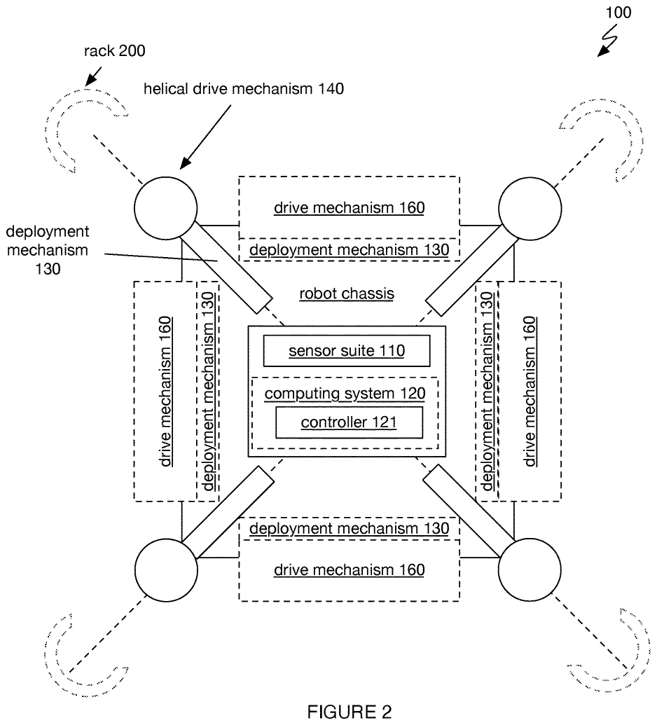

The system 100, an example of which is shown in FIG. 2, can include: a sensor suite 110, a computing system 120, a deployment mechanism 130, a helical drive mechanism 140 and/or any other suitable components. The system can optionally include or operate in conjunction with a rack 200 (e.g., within a support frame structure). However, the system 100 can additionally or alternatively include any other suitable set of components. The system functions to estimate the relative ego pose (e.g., helical drive angular rotation and/or vertical position) of the robot relative to the rack. Additionally or alternatively, the system can function to control the helical drive mechanism to facilitate rack engagement and/or vertical control (e.g., granular control, such as within 1 mm, even under coarse relative tolerances, such as frame flexure/displacements greater than 1 cm).

The sensor suite 110 functions to collect measurements for feedback controls and can additionally function to facilitate autonomous perception and control of the robot system. The sensor suite can include: rack sensors (a.k.a., Z-drive sensors), internal sensors (e.g., encoders, actuator sensors, accelerometers, gyroscopes, IMU, INS, temperature sensors, voltage/current sensors, etc.), environmental sensors, antennas (e.g., GPS, cellular, Bluetooth, Wi-Fi, Near Field Communication, etc.), drive mechanism sensors (e.g., encoders, cameras, time-of-flight sensors, 3D-scanners, depth image sensors, voltage/current sensors, accelerometers, force sensors, contact sensors, etc.; inboard and/or outboard ends, such as encoders at both the actuator and the wheel), wheel encoders, deployment mechanism sensors (e.g., position sensing, etc.), payload sensors (e.g., force sensors/switches, cameras, proximity sensors, payload envelope sensors, payload engagement sensors, etc.), perception suite sensors (e.g., cameras, 3D scanners, laser imaging arrays, time-of-flight sensors, proximity sensors, radar, Lidar, etc.; support frame sensors, etc.), integrated actuator sensors, and/or any other suitable set of sensors. The sensors can include one or more: Radar sensors, LIDAR sensors, cameras, camera arrays, time-of-flight sensors, time-of-flight arrays, spatial sensors, location sensors, force sensors, on-board diagnostic sensors (such as vehicle mechanism sensors), audio sensors, barometers, light sensors, temperature sensors, current sensors, voltmeters, contact sensors, proximity sensors, vibration sensors, ultrasound sensors, electrical sensors, pressure sensors, and/or any other suitable sensors. However, the robot can include any other suitable sensors.

The sensor suite can include one or more rack sensor(s) (e.g., at an outboard end of the helical drive; articulated along the D-drive axis). For instance, the rack sensors can include: a unitary sensor (e.g., TOF; laser-ranging; depth sensor; etc.), a 1-D sensor array (e.g., azimuthal array, an example of which is shown in FIG. 7; polar array, an example of which is shown in FIG. 8), a 2-D sensor array (e.g., depth imaging array; TOF array, 3D scanner, etc.; an example is shown in FIG. 9), and/or any other suitable sensors. Rack sensors are preferably arranged at a distal end of each helical drive mechanism, but can additionally or alternatively be mounted to the arm, chassis (e.g., along a diagonal; offset from and/or parallel with a diagonal; etc.), integrated with a subset of the helical drive mechanism(s) or arm(s), and/or otherwise suitably arranged.

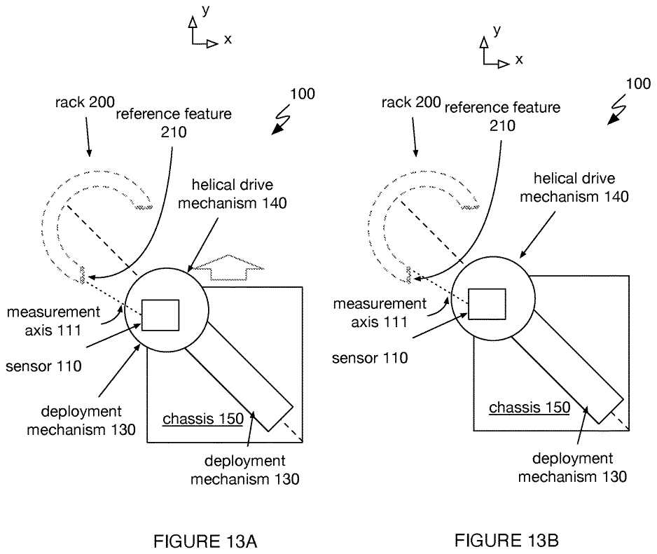

In a preferred variant, the rack sensor(s) can include a single-point distance sensor (e.g., a single-point laser distance sensor; a single-point time-of-flight sensor; an optical triangulation sensor; a single-point infrared distance sensor). The single-point distance sensor can be rigidly mounted (e.g., at a fixed position and orientation) to the helical drive mechanism (and/or another suitable robot component), wherein the deployment motion of the helical drive mechanism along the D-drive axis and/or the traversal motion of the helical drive mechanism along a X- or Y-axis provides the scanning degree of freedom that converts the single-point distance measurements into a spatial profile of the rack (e.g., a two-dimensional scan; example shown in FIGS. 13A-13B). In such variants, no additional mechanical scanning degree of freedom (e.g., no pivoting, rotating, or oscillating mount) is required to capture the spatial profile. However, the sensor can alternatively include a mechanically scanned mount and/or any other suitable mounting arrangement.

In a first variation, the single-point sensor can be mounted at a fixed angle relative to the D-drive axis (e.g., with a beam axis angled between 25 degrees and 45 degrees relative to the D-drive axis; between 15 degrees and 45 degrees; or at any other suitable angle), such that deployment of the helical drive mechanism along the D-drive axis sweeps the sensor beam across the helical features of the rack and/or other features on the rack.

In a second variation, the single-point sensor can be mounted with its beam axis oriented substantially perpendicular to the longitudinal axis of the rack (e.g., pointing substantially horizontally toward the rack). In such variations, the scanning degree of freedom can be provided by motion of the robot along the longitudinal axis of the rack (e.g., via drive wheels of the robot entering or traversing a cell), rather than by D-drive deployment. The sensor can capture distance measurements relative to molded-in features on a lip of the rack (e.g., entry rack features distinct from the helical engagement pattern) as the robot moves past the features.

However, the sensor suite can include any other suitable sensor(s) and/or sensor array(s).

The rack sensors preferably define a fixed mounting angle(s) (e.g., azimuthal angle; azimuthal and polar angles) and/or angular range. For example, a rack sensor (aligned with the diagonal and/or D-drive axis) can define an azimuthal angle of about 30 degrees, which can be used to detect key points in a diagonal reference plane and/or estimate the distance to the central axis of the rack (e.g., Y-distance to the key point is the distance measured to the key point times cosine(theta) for azimuthal angle theta, where offsets for known parameters can be used to estimate the distance from the helical drive axis to the central axis of the rack). The positive (and/or negative) azimuthal angle(s) can be o degrees, 5 degrees, 10 degrees, 15 degrees, 20 degrees, 25 degrees, 30 degrees, 35 degrees, 40 degrees, 45 degrees, 50 degrees, greater than 50 degrees, any open or closed range bounded by the aforementioned values, and/or any other suitable angle(s) or angular range(s). In a preferred variant, the positive azimuthal angle(s) can be between 25 degrees and 45 degrees (e.g., wherein angles below approximately 25 degrees may yield insufficient sensitivity to the helical structure of the rack, and/or angles above 45 degrees may result in occlusion or insufficient range variation). However, in alternative variants, azimuthal angles between 15 degrees and 25 degrees can be suitable. Likewise, the rack sensors preferably span a polar angle of zero relative to the reference diagonal (e.g., aligned with the diagonal and/or D-drive), but can additionally or alternatively span an azimuthal range of o degrees, 5 degrees, 10 degrees, 15 degrees, 30 degrees, greater than 30 degrees, any open or closed range bounded by the aforementioned values, and/or any other suitable azimuthal range(s). However, the system can include any other suitable rack sensors and/or rack sensor array(s) with any suitable mounting angle(s).

In variants, the mounting angle range of between about 15 degrees and about 45 degrees from the axis of actuation (e.g., D-drive axis) provides a favorable trade-off between waveform contrast and key point sampling density during deployment travel. At angles below approximately 15 degrees, the sensor line of sight approaches a grazing incidence relative to the helical rack surface, which can reduce the amplitude of peaks and troughs in the sensed distance waveform and thereby degrade the reliability of key point detection (e.g., peak detection sensitivity). In alternative variants, a range above 25 degrees can further improve the reliability of key point detection (e.g., between 25 and 45 degrees). At angles above approximately 45 degrees, the sensor field of view intercepts fewer helical rack threads per unit of travel along the axis of actuation, which can reduce the number of key points available for ego state estimation during a single deployment stroke and can additionally cause the sensor to observe open space beyond the rack extent (e.g., on upper levels of a multi-level support frame), thereby introducing erroneous distance measurements. Within the range of about 15 degrees to about 45 degrees, the sensor produces a distance waveform with sufficient peak-to-trough contrast for reliable key point detection while maintaining adequate spatial sampling of the rack geometry across the deployment stroke.

Sensor data can be evaluated for individual image frames (e.g., examples are shown in FIG. 12), captured with any suitable frequency (e.g., less than 1 Hz, 1 Hz, 3 Hz, 5 Hz, 10 Hz, 15 Hz, 20 Hz, 30 Hz, greater than 30 Hz, any open or closed range bounded by the aforementioned values, etc.). Additionally or alternatively, sensor data can be captured and analyzed as a time series (e.g., examples are shown in FIGS. 4A-4B, FIG. 5, and FIG. 6).

The sensor suite can facilitate odometry, localization relative to frame features (e.g., cells and/or coordinate positions therein; helical rack geometry; fiducials; etc.), dead reckoning, and/or can otherwise facilitate localization within the frame structure. Additionally or alternatively, the sensor suite can facilitate fault detection and/or anomaly detection during vertical traversal of the robot along the rack (e.g., while the helical drive is engaged and the robot is climbing). For example, sensor data collected during vertical traversal can be used to detect disengagement of the helical drive from the rack (e.g., based on an unexpected change in the sensed distance waveform indicative of decoupling), to independently verify traversal speed (e.g., as a redundancy for a rotary encoder on the helical drive), and/or to detect wear or damage to the rack. However, the sensor suite can be otherwise suitably used during vertical traversal.

The sensors are preferably communicatively coupled to the computing system to facilitate perception and/or control. For instance, the sensor suite can be configured to collect data at various frequencies and/or resolutions, depending on the specific requirements of the operating environment. The collected data can be processed and analyzed in real-time (or near real time) to inform the autonomous decision-making and control at the computing system.

However, the system can include any other suitable sensor suite and/or any other suitable sensor(s).

The system can include or be used in conjunction with a computing system 120. which can include a central computer and/or a plurality of actuator controllers 121 thereof. The computing system and/or various computing operations thereof can be centralized, distributed (e.g., modularized), local/onboard, remote and/or otherwise implemented. The computing system preferably controls actuation based on sensor feedback (e.g., CAN/LIN network communications) and/or facilitate I/O communication (e.g., with a remote server, remote/centralized planner, cloud computing resources, external data storage, HMI control system, etc.). The computing system and/or the controller(s) thereof can include: one or more: CPUs, GPUs, custom FPGA/ASICS, microprocessors, servers, cloud computing, and/or any other suitable components. The controllers and/or elements of the computing system can be communicatively coupled in series, parallel, and/or any combination thereof (e.g., parallel/star configuration). However, the computing system can be otherwise configured.

The computing system can receive sensory inputs/measurements from the sensor suite, which can be used to determine a vehicle state and dynamically control the system 100 based on the vehicle state. For example, the computing system can control deployment mechanisms to effect system configuration change(s) and/or control the drive system(s) based on the vehicle state.

The computing system preferably includes a controller which functions to control the helical drive mechanism(s), the deployment mechanism(s), and/or the actuators thereof. For example, the computing system can include the controller(s) as described in U.S. application Ser. No. 19/046,366, filed 5 Feb. 2024, which is incorporated herein in its entirety by this reference. However, the computing system can be otherwise configured.

However, the system can include and/or operate in conjunction with any other suitable computing system and/or controller(s) thereof.

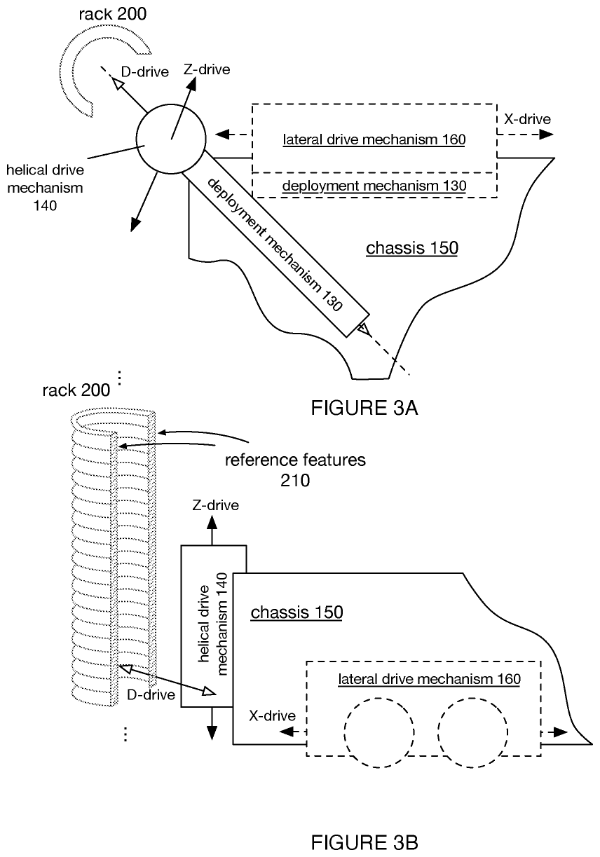

The system can include a helical drive mechanism(s) 140 which functions to vertically actuate the system along the rack (e.g., Z-drive axis; an example is shown in FIGS. 3A-3B). In variants, the helical drive mechanism(s) can include all or a portion of the system(s) and/or element(s) as described in U.S. application Ser. No. 18/531,184, filed 6 Dec. 2023, U.S. application Ser. No. 19/046,366, filed 5 Feb. 2025, and/or U.S. application Ser. No. 19/056,180, filed 18 Feb. 2025, each of which is incorporated herein in its entirety by this reference.

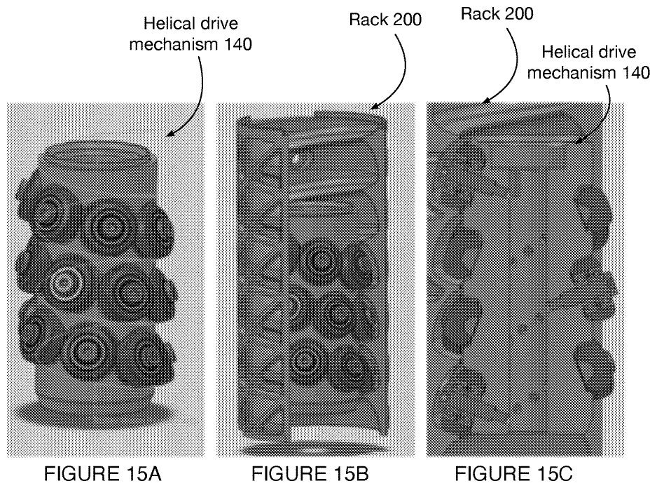

The helical drive mechanism preferably includes a worm (e.g., a helical worm gear) configured to mesh with helical teeth of the rack upon engagement. The worm defines a set of helical features (e.g., worm threads and/or rollers; example shown in FIGS. 15A-15C) that correspond to and are configured to interlock with the helical engagement features of the rack (e.g., the helical rack teeth). The helical drive mechanism can additionally include: a helical drive actuator (e.g., an electric motor) and/or any other suitable components (e.g., an example is shown in FIG. 11). In variants, the helical drive mechanism can additionally include a multi-roller wheel assembly (e.g., configured to engage the rack and/or guide the helical drive mechanism during traversal; an example is shown in FIG. 11).

In variants, the helical drive mechanism can be controlled by the controller in linear units (e.g., millimeters of vertical displacement along the Z-axis) rather than in angular units (e.g., radians of worm rotation). For example, the helical drive actuator controller can include a built-in conversion ratio (e.g., a motor rotor-to-output ratio) that transforms angular rotation of the motor into linear displacement along the Z-axis, such that the control input to the helical drive is a target height (e.g., in millimeters) and the angular position of the worm is derived internally by the controller (e.g., based on a calibrated degrees-per-millimeter conversion factor). In such variants, the helical drive can be controlled as a substantially linear actuator from the perspective of the computing system, even though the underlying mechanism is rotational. However, the helical drive mechanism can alternatively be controlled in angular units and/or with any other suitable control representation.

The robot can include a plurality of helical drive mechanisms (e.g., four helical drive mechanisms, one at each corner of the robot). In a first variant, the plurality of helical drive mechanisms can be all same-handed (e.g., all right-hand or all left-hand helical drives). In a second variant, the plurality of helical drive mechanisms can include two right-hand helical drives and two left-hand helical drives (e.g., paired diagonally, such that helical drives at opposing corners of the robot share the same handedness). Each helical drive mechanism can be independently actuated and controlled (e.g., to facilitate Z traversal while maintaining chassis orientation, and/or to independently align each helical drive with its respective rack prior to engagement). However, the helical drive mechanisms can be collectively controlled, mechanically coupled, and/or otherwise configured.

However, the system can include any other suitable helical drive mechanism(s) and/or can be otherwise configured.

The system can include a rack 200, which functions to engage with the helical drive mechanisms during traversal of the cell frame structure. In variants, the rack can be the rack described in U.S. application Ser. No. 18/531,184, filed 6 Dec. 2023, U.S. application Ser. No. 19/046,366, filed 5 Feb. 2025, and/or U.S. application Ser. No. 19/056,180, filed 18 Feb. 2025, each of which is incorporated herein in its entirety by this reference.

The rack can include a plurality of rack sections, including an entry rack section and one or more intermediate rack sections. The entry rack section is preferably a distinct component (e.g., a separately molded part) located at a position along the rack where the helical drive initially engages the rack (e.g., at the point of cell entry, etc.). The entry rack section can include the helical engagement features (e.g., a set of helical worm gear rack teeth) and can additionally include a set of reference features (a.k.a. index features, clocking features, registration features) arranged on the entry rack section. The reference features are preferably spatially offset from the helical engagement surface of the rack (e.g., arranged on a lip, an edge, a flange, and/or any other non-engagement surface of the rack) such that the reference features do not interfere with the helical engagement pattern and/or the helical drive engagement. Alternatively, the reference features can be the same as the helical engagement features

The reference features are preferably integrated into the entry rack section as a unitary component (e.g., molded into the entry rack during manufacture, without requiring a separate part, adhesive, printing, or post-processing). The reference features can include: a three-dimensional profile (e.g., a sloped surface, a ramp, a wedge, a stepped profile, a sawtooth profile, and/or any other suitable three-dimensional geometry) configured to produce a monotonically varying distance measurement as a function of sensor position along the longitudinal axis of the rack. The reference features can additionally or alternatively include: a notch, a ridge, a groove, a detent, a set of fiducial markers, an optical code (e.g., a barcode, a QR code, and/or any other machine-readable pattern printed or applied to the rack), and/or any other suitable features. However, the reference features can be otherwise suitably configured.

In variants, the reference features can be arranged on opposing sides of the rack (e.g., on opposing lips of the entry rack section, such that the features are accessible regardless of the direction from which the robot enters the cell). The reference features on opposing sides can be substantially symmetric (e.g., mirrored about the central axis of the rack) and/or can be otherwise suitably arranged. Additionally, the reference features are preferably arranged to avoid interference with a bolt pattern of the rack (e.g., offset from bolt holes used to fasten the entry rack section to the frame structure).

However, in variants, the reference features can be omitted from the rack (e.g., wherein the sensor instead detects features of the helical engagement surface itself, such as peaks and/or valleys of the helical rack teeth).

However, the rack can be otherwise configured.

The system can include a deployment mechanism(s) 130 which functions to deploy the helical drive mechanism(s) along a deployment axis (e.g., D-drive axis; an example is shown in FIGS. 3A-3B). The deployment mechanism(s) are preferably controlled by the computing system and/or a controller thereof (e.g., via S140), but can additionally or alternatively be controlled independently of the helical drive (e.g., decoupled from the state of the helical drive mechanism), and/or can be otherwise controlled. In variants, the deployment mechanism can be the deployment mechanism described in U.S. application Ser. No. 19/046,366, filed 5 Feb. 2025. In an example, the system includes four deployment mechanisms, one at each corner of the robot (e.g., at opposing ends of two diagonals of the robot).

However, the system can include any other suitable deployment mechanism(s) and/or can be otherwise configured.

However, the system can include any other suitable components.

In some variants, sensor data from the sensor suite can optionally be processed using a set of models of the computing system. For example, the models can include a plurality of neural network layers (e.g., two convolutional layers) trained to detect/estimate a key point (e.g., 1D height rack feature or centerline thereof) based on a depth image, which can be used to estimate the relative pose of the robot and/or control the robot relative to the rack (e.g., align the helical drive with the rack). The models can include classical or traditional approaches, machine learning approaches, and/or be otherwise configured. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naiive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

### 5. Method

The method 1000, an example of which is shown in FIG. 1, can include: determining sensor data S110; detecting a rack key point S120; and estimating an ego state based on the key point S130. The method can optionally include controlling the robot based on the ego state S140. However, the method can additionally or alternatively include any other suitable elements. The method functions to facilitate robot pose estimation relative to a rack. Additionally or alternatively, the method can function to facilitate rack engagement and/or granular control of a helical drive mechanism (e.g., under coarse structural tolerances).

Determining sensor data S110 functions to receive inputs to be used for rack key point determination and/or rack-relative pose estimation. The sensor data is preferably collected by one or more sensor(s) of the sensor suite and received at the computing system, but can be otherwise suitably determined (e.g., received from a remote endpoint, etc.). The sensor data can include: depth data, depth image data (e.g., 2D depth map of depth pixels), low resolution 3D scans, and/or any other suitable sensor data. The sensor data can include any suitable pixel granularity and/or resolution. For example, image frames can include 1 pixel (e.g., a distance/depth measurement), 3 pixels (e.g., 1×3 pixel array), 6 pixels (e.g., 1×6 pixel array), 8 pixels (e.g., 1×8 pixel array), 24 pixels (e.g., 3×8 pixel array), 64 pixels (e.g., 8×8 pixel array), 128 pixels, 256 pixels, and/or any other suitable number of (depth) pixels.

In variants, the sensors can include high-definition depth imaging sensors (e.g., HD image quality; high accuracy depth measurements, such as at least 0.1 mm precision; etc.), which can yield high accuracy key point detection and/or state estimation. However, this may significantly increase the cost of sensors and/or may pose practical challenges with sensor integration, since existing near field depth scanners are not typically designed to operate across the regime of depths that may be observed by the system (e.g., where depth observations may range from about 1 centimeter to about 40 centimeters; based on the deployment stroke length and angle). Additionally, the real-time processing requirements scale with the data volume, so it may additionally be expensive in terms of component cost and computing requirements to rely on such sensors (e.g., relying on low resolution sensors may be multiple orders of magnitude less expensive in terms of sensor cost and computing requirements). For example, a high accuracy time-of-flight sensor can be used where accuracy is preferred. Additionally or alternatively, an (inexpensive) sensor array can gather coarse sensor data in place of the (expensive) highly-granular sensor(s).

Sensor data can be determined for individual data frames (e.g., with a predetermined measurement frequency) and/or stored and referenced in a time series. In a first variant, the sensor data can include a time series of measurements from a single sensor (e.g., at a fixed and/or known angle, such as between 15 degrees and 45 degrees), examples of which are shown in FIG. 5 and FIG. 6. In a second variant, the sensor data can include 1-D array of depth imaging data (e.g., azimuthal array, an example is shown in FIG. 7; polar array, an example is shown in FIG. 8; uniform or non-uniform angular spacing). In a third variant, the sensor data can include 2D-depth image maps (e.g., azimuthal and polar array; an example is shown in FIG. 9 and FIG. 12).

In a specific example, the sensor data can include a time series of single-point distance measurements captured during motion (e.g., lateral motion) of the sensor relative to the frame structure (e.g., during helical drive mechanism deployment, or as the robot enters a cell of the frame structure using drive wheels), wherein the sensor's motion along an axis perpendicular to the longitudinal axis of the rack (e.g., the Z-axis) provides the scanning degree of freedom. In such variants, the sensor can be oriented with a measurement axis 111 substantially perpendicular to the gravitational axis (e.g., pointing substantially horizontally toward the rack lip), and can capture distance measurements relative to the reference features (e.g., molded-in features on the entry rack lip) as the robot traverses past the reference features. The sequence of distance measurements can vary as a function of the robot's position along the longitudinal axis, and the variation can be used to determine the robot's height relative to the rack and/or to estimate the ego state. The scanning degree of freedom in this variant is the robot's drive wheel motion, rather than the D-drive deployment motion, and the sensor data can be captured prior to deployment of the helical drive mechanism.

However, sensor data can be otherwise suitably determined.

Detecting a rack key point S120 functions to detect a key point on the rack to facilitate ego state estimation relative to the key point and/or locate the Z-drive (and/or helical drive/sensor) coordinate frame relative to the rack. Additionally or alternatively, S120 can determine a key point position along the Z-drive axis to facilitate ego state estimation and/or control.

Key points are preferably detected independently of the D-drive position along the D-axis, but can additionally or alternatively be detected relative to the D-drive position along the D-axis (e.g., where the relative displacement along the Y-axis is used to estimate waveform peaks; an example is shown in FIGS. 4A and 4B; where absolute distance between the helical drive and the rack may be determined based on the distance to the detected key points).

Key points are preferably detected using the sensor data measured by the rack sensor(s) for a current data frame (e.g., for each iteration of S120), but can additionally or alternatively be determined using historical data frames (e.g., smoothing and/or tracking key points across multiple data frames). Given the helical structure of the rack, the sensor data may capture a (repeating) waveform as a function of traversal along either axis of a diagonal reference plane defined by the D-drive axis and the Z-drive axis (e.g., though during deployment of the helical drive and/or with the helical drive disengaged, it may be assumed for localization purposes that the position of the robot is static relative to the frame; an example is shown in FIG. 6). From this waveform, key points can be detected using classical algorithmic techniques and/or the set of models (e.g., model based key point detection/estimation) to index relative position along the central axis rack (a.k.a. Z-value), within one step of the helical rack (e.g., worm gear ‘step’). The key points detected in S120 preferably define peaks and/or local maxima of the helical rack along a reference plane defined by the D-drive axis and the Z-drive axis of the robot (e.g., a diagonal plane of the robot), but can additionally or alternatively define a known offset/relationship to a peak (e.g., an example is shown in FIG. 5), troughs (or local minima) an intersection of a curve or line segment with the reference plane at the, a height of the key point along the Z-drive axis, a key point position of in the reference plane, and/or the key point(s), and/or can be otherwise suitably defined. Accordingly, in sensor coordinates, key points can correspond to local maxima (or minima) in the derivative of sensed distance versus Y-position (e.g., an example is shown in FIG. 5), vertices in the residual relative to a reference (e.g., where the peaks of the rack may have the highest residual relative to a line corresponding to the of the troughs or line of best fit), Key points can be detected relative to a waveform a single coordinate dimension (e.g., azimuthal coordinate, polar coordinate, Y-axis coordinates, Z-axis coordinates, etc.) and/or multiple coordinate dimensions (e.g., azimuthal and polar coordinates; 2D array). Additionally or alternatively, it is understood that sensor data can be transformed and/or analyzed in any suitable coordinate frame(s), such as spherical coordinates, cylindrical coordinates, rectilinear coordinates, and/or helical coordinates. As an example, (learned) deterministic transforms (e.g., CNN model) may estimate a key point position (e.g., Z-value along the Z-axis) based on a frame of a spherical coordinate depth image. Likewise, a Z-value of the key point can be transformed into a Z-drive rotation, and vice versa, by coordinate transform (e.g., within a helical drive controller; such as described in U.S. application Ser. No. 19/046,366, filed 5 Feb. 2025).

In a first variant, a key point can be determined based on a centerline estimated from a 2D depth image (e.g., where the key point is the intersection of the centerline with the diagonal reference plane; an example is shown in FIG. 9)

In a second variant, a key point can be estimated based on a time series of distance measurements based on relative D-drive position (e.g., an example is shown in FIGS. 4A-4B, FIG. 5, and FIG. 6).

In a third variant, a key point value (e.g., Z-value) can be determined using the set of models (e.g., an example is shown in FIG. 12).

However, a rack key point(s) can be otherwise suitably detected and/or determined.

Key points are preferably detected independently of the helical drive deployment and/or absolute sensor position along the D-drive axis (e.g., wherein the set of sensor data inputs used for S120 may exclude the relative deployment along the D-drive axis). In such variants, key points detections can be used to localize the sensor(s) relative to the rack and/or a central axis thereof, which can be used to estimate the relative position of the helical drive along the Y-axis. For example, as a result of variable loads and structural tolerances, the rack and central axis thereof may have a deflection of a centimeter or more along the height of the rack (e.g., relative to a gravity vector), thus the distance between the D-drive and the rack may vary by more than a centimeter for a given D-drive position.

Estimating an ego state based on the key point S130 functions to determine the state of the ego robot relative to the rack key point and/or localize the robot relative to the central axis of the rack. For example, the relative rotation of the (each) helical drive and/or target D-drive displacement along the D-axis may be referenced and/or recalibrated relative to the key point detection on the (respective) rack, prior to engagement of the helical drive with the rack. In particular, updating the ego state estimate and/or target helical drive position may ensure that the helical drive mechanism (worm) meshes with the rack upon initial contact/engagement, an example of which is shown in FIGS. 10A-10B.

The ego state is preferably estimated based on a pre-defined and/or deterministic transformation relative to the sensor pose(es) and/or mounting angle(s) relative to the diagonal reference plane. Additionally or alternatively, the ego state can estimate and/or update a set of helical coordinates using the key point value(s) in Z (and/or Y) as the reference(s).

In a first variant, the ego state is estimated by triangulating a position of the sensor (and/or helical drive mechanism) relative to the key point. In a second variant, the ego state is directly referenced against the value of the key point (e.g., along the Z-axis), wherein a key point positional value(s) directly estimates an ego state parameter value(s). In a third variant, the ego state is estimated by tracking the keypoint(s) across multiple data frames. In a fourth variant, the ego state can be estimated and/or updated using any one or more of the method elements(s) as described in U.S. application Ser. No. 19/046,366, filed 5 Feb. 2025.

However, the ego state estimation can be otherwise determined. Additionally or alternatively, the ego state can be indexed against the rack key point(s) and/or controller(s) can directly control the helical drive in terms of the key point (and/or rack height/Z-drive coordinates), such as where the helical drive angle transformation is integrated into the controller (e.g., controller receives rack height, rather than angular orientation, as the control input).

The method can optionally include controlling the robot based on the ego state S140. S140 can include: deploying the helical drive S142 (e.g., D-drive actuation); Controlling the helical drive S144 (e.g., Z-drive actuation). The helical drive deployment and control can preferably occur synchronously and/or contemporaneously based on the ego state (e.g., where the helical drive is controlled to align and mesh with the rack during deployment), but can additionally or alternatively occur asynchronously, responsive to determination of a trigger event (e.g., based on the ego state satisfying a threshold condition, etc.), and/or with any other suitable timing/frequency. In a first variant, the helical drive deployment and/or D-drive control can be mathematically decoupled from the Z-drive control (e.g., such as by the controller(s) described in U.S. application Ser. No. 19/046,366, filed 5 Feb. 2025).

Additionally or alternatively, S140 can include validating engagement of the helical drive with the rack S146. Validating engagement can include: detecting spring compression along the deployment axis (e.g., via a spring sensor in line with the deployment mechanism, such as a linear position sensor measuring compression of a compliant element between the helical drive mechanism and the chassis); estimating torque on the helical drive actuator (e.g., based on motor current); and/or detecting a consistent load on the helical drive actuator indicative of proper meshing (e.g., wherein engagement produces a characteristic torque profile when the helical drive is actuated, and disengagement or partial engagement produces a different torque profile). In a preferred variant, S146 can include validating engagement based on a combination of spring compression and estimated torque (e.g., wherein the spring sensor detects that the helical drive has contacted the rack, and the estimated torque validates that the helical drive is properly meshed and under load). However, engagement can be otherwise suitably validated.

Additionally, sensor data from the rack sensor(s) can be used during vertical traversal (e.g., after engagement and during climbing) to monitor engagement status, detect anomalous conditions (e.g., unintentional disengagement, excessive wear), and/or independently verify traversal speed (e.g., as a redundancy for the rotary encoder on the helical drive mechanism). However, the method can include any other suitable monitoring and/or can be otherwise performed during vertical traversal.

However, S140 can be otherwise performed.

Alternatively, the robot can cooperatively control the helical drive and the deployment mechanism(s), and/or the robot can be otherwise suitably controlled.

Additionally or alternatively, the method can be used to facilitate updates to the ego state and localization relative to the rack after deployment of the helical drive and/or with any other suitable timing. However, the robot and/or system can be otherwise suitably controlled.

However, the method can include any other suitable elements and/or can be otherwise performed.

The method is preferably performed during deployment (and/or engagement) of the helical drive and/or contemporaneous actuation/control of the helical drive (e.g., contemporaneously with S142 and/or S144), but can be performed during any other suitable control modes and/or operational regimes of the robotic system. Additionally or alternatively, the method can be performed during robot traversal (e.g., in any suitable degrees of freedom) and/or with any other suitable timing. Additionally or alternatively, all or portions of the method can be performed in real time (e.g., responsive to a request), iteratively, repeatedly, concurrently, asynchronously, periodically, and/or at any other suitable timing/frequency. All or portions of the method can be performed automatically, manually, semi-automatically, and/or otherwise performed. All or portions of the method can be performed by one or more components of the system, using the computing system (e.g., automatically and/or autonomously), using a database (e.g., a system database, a third-party database, etc.), responsive to a request by a user, and/or by any other suitable system(s). The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

1. A method for a robot, the method comprising:
controlling actuation of a first robot component of the robot relative to a frame structure, wherein the frame structure comprises a rack;
during actuation of the first robot component, using a sensor statically mounted to the first robot component, capturing a sequence of distance measurements;
based on the sequence of distance measurements, detecting a set of features on the frame structure;
based on the set of features, estimating an offset between a worm gear of the first robot component and the rack;
based on the offset, aligning the worm gear with the rack by rotating the worm gear relative to the robot; and
after aligning the worm gear with the rack, engaging the worm gear with the rack.

2. The method of claim 1, wherein the sensor comprises a single-point sensor.

3. The method of claim 2, wherein actuation of the first robot component is along an axis of actuation, and wherein the sensor is mounted to the first robot component at a fixed angle between 15 degrees and 45 degrees from the axis of actuation.

4. The method of claim 1, wherein the method further comprises:
controlling actuation of a second robot component of the robot, wherein the first robot component and second robot component are arranged in opposition across a diagonal of the robot;
during actuation of the second robot component, capturing a second sequence of distance measurements using a second sensor mounted to the second robot component; and
based on the second sequence of distance measurements, aligning a second worm gear of the second robot component with a second rack.

5. The method of claim 4, wherein aligning the worm gear comprises aligning the worm gear independently of aligning the second worm gear with the second rack.

6. The method of claim 1, wherein the worm gear comprises a plurality of rollers.

7. The method of claim 1, wherein the set of features is integrated into the rack as a unitary component.

8. The method of claim 7, wherein the set of features comprise a three-dimensional pattern.

9. The method of claim 1, wherein the offset is along a gravity vector.

10. The method of claim 1, wherein the first robot component is mechanically coupled to a chassis of the robot via an arm, wherein controlling actuation of the first robot component comprises actuating the arm relative to the chassis.

11. The method of claim 10, wherein actuation of the arm relative to the chassis is along an axis of actuation angled relative to a measurement axis of the sensor.

12. The method of claim 1, wherein the first robot component is mechanically coupled to a chassis of the robot, wherein controlling actuation of the first robot component comprises controlling actuation of the chassis relative to the rack.

13. The method of claim 12, wherein the rack is within a 3D frame defining a cell, and wherein controlling actuation of the chassis comprises controlling motion of the robot entering the cell.

14. The method of claim 1, wherein the offset is linear, and wherein the method further comprises transforming the offset into a target rotational position of the worm gear, wherein aligning the worm gear with the rack is based on the target rotational position.

15. The method of claim 1, wherein aligning the worm gear with the rack is performed concurrently with controlling actuation of the first robot component.

16. A system, comprising:
a rack comprising a track arranged along a long axis of the rack; and
a robot comprising:
a plurality of robot arms;
a chassis;
an actuator mounted to a first robot arm of the plurality of robot arms and configured to actuate the first robot arm along an actuation axis angled relative to the long axis;
a sensor statically mounted to the first robot arm; and
a computing system mounted to the chassis, the computing system configured to:
control actuation of the first robot arm along the actuation axis;
during actuation of the first robot arm along the actuation axis, command the sensor to capture a sequence of distance measurements, each distance measurement of the sequence corresponding to a distinct respective height along the long axis;
based on the sequence of distance measurements, determine an offset between the first robot arm and the rack; and
based on the offset, control the first robot arm to align with the track.

17. The system of claim 16, wherein the rack is directly mounted to a frame structure defining a 3D rectilinear grid of cells, and wherein the actuation axis is diagonal relative to each orthogonal axis of the 3D rectilinear grid of cells.

18. The system of claim 16, wherein the plurality of robot arms comprises a set of four robot arms, wherein each robot arm of the set of four robot arms is mechanically coupled to a different respective corner of the chassis via a respective actuator.

19. The system of claim 16, wherein the computing system is configured to control the first robot arm based on input from the sensor and independent of input from sensors associated with other robot arms of the robot.

20. The system of claim 16, wherein the sequence of distance measurements is relative to a set of features of the rack, wherein the set of features is distinct from the track.
